(19) United States
(12) Patent Application Publication
(10) Pub. No.: US 2023/0114528 A1
(43) Pub. Date: Apr. 13, 2023

(54) CLEANER

(71) Applicant: MAKITA CORPORATION, Anjo-shi, Aichi (JP)

(72) Inventors: Shinya BITO, Anjo-shi (JP); Akinori ITO, Anjo-shi (JP)

(73) Assignee: MAKITA CORPORATION, Anjo-shi, Aichi (JP)

(21) Appl. No.: 17/907,760

(22) PCT Filed: Jan. 19, 2021
(86) PCT No.: PCT/JP2021/001585

§ 371 Date: Aug. 29, 2022

(30) Foreign Application Priority Data
Apr. 9, 2020 (JP) 2020-070579

(51) Int. Cl. A47L 9/16; A47L 5/24; A47L 9/12; B04C 3/06; B04C 9/00; B01D 46/00

(52) U.S. Cl. CPC A47L 9/1666; A47L 5/24; A47L 9/1691; A47L 9/1683; A47L 9/165; A47L 9/122; B04C 3/06; B04C 9/00; B01D 46/0002; B04C 2009/002; B04C 2009/005; B01D 2271/02; B01D 2279/55

(57) ABSTRACT

A cleaner including a cyclone dust collector and a filter has a shortened total length. The cleaner includes a main unit including a suction port, a cyclone unit including a cyclone dust collector having an outlet and a cylinder located rearward from the outlet and having an opening larger than the outlet, and a filter located frontward from the suction port and covering the opening.

### FIELD

The present disclosure relates to a cleaner.

### BACKGROUND

In the field of cleaners, one known vacuum cleaner includes a cyclone dust collector, as described in Japanese Unexamined Patent Application Publication No. 2001-269297. In the field of cleaners, another known vacuum cleaner includes a filter, as described in Japanese Unexamined Patent Application Publication No. 2017-000393.

### BRIEF SUMMARY

### Technical Problem

One or more aspects of the present disclosure are directed to a cleaner with a shortened total length including a cyclone dust collector and a filter.

### Solution to Problem

A first aspect of the present disclosure provides a cleaner, including:

a main unit including a suction port;

a cyclone unit including
a cyclone dust collector having an outlet, and
a cylinder located rearward from the outlet of the cyclone dust collector, the cylinder having an opening larger than the outlet of the cyclone dust collector; and

a filter located frontward from the suction port and covering the opening,

### advantageous effects

The cleaner according to the above aspect of the present disclosure including the cyclone dust collector and the filter has a shortened total length.

### BRIEF DESCRIPTION OF DRAWINGS

FIG. 1 is a diagram of a cleaner in an example use according to an embodiment.

FIG. 2 is a front perspective view of the cleaner according to the embodiment.

FIG. 3 is a rear perspective view of the cleaner according to the embodiment.

FIG. 4 is a cross-sectional view of the cleaner according to the embodiment.

FIG. 5 is an exploded perspective view of the cleaner according to the embodiment as viewed from the front.

FIG. 6 is an exploded perspective view of the cleaner according to the embodiment as viewed from the rear.

FIG. 7 is an exploded perspective view of a filter unit in the embodiment as viewed from the front.

FIG. 8 is an exploded perspective view of the filter unit in the embodiment as viewed from the rear.

FIG. 9 is an exploded perspective view of a cyclone unit in the embodiment as viewed from the front.

FIG. 10 is an exploded perspective view of the cyclone unit in the embodiment as viewed from the rear.

FIG. 11 is a diagram describing the relationship between the filter unit and the cyclone unit in the embodiment.

FIG. 12 is a diagram of a cleaner in an example use according to the embodiment.

### DETAILED DESCRIPTION

Although one or more embodiments of the present disclosure will now be described with reference to the drawings, the present disclosure is not limited to the embodiments. The components in the embodiments described below may be combined as appropriate. One or more components may be eliminated.

In the embodiments, the positional relationships between the components will be described using the directional terms such as front and rear (or forward and backward), right and left (or lateral), and up and down (or vertical). The terms indicate relative positions or directions with respect to the center of a cleaner 1.

### Overview of Cleaner

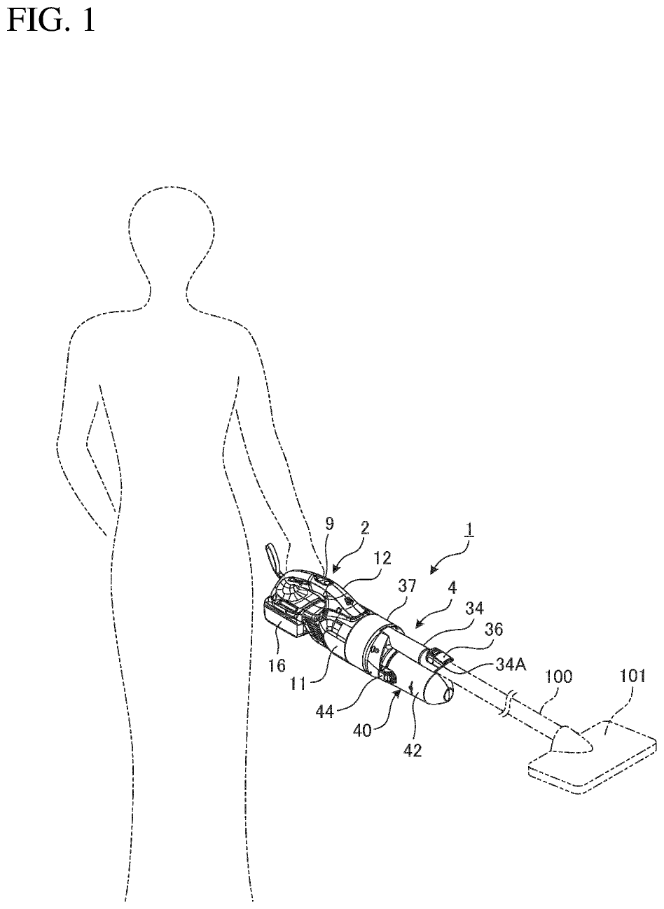

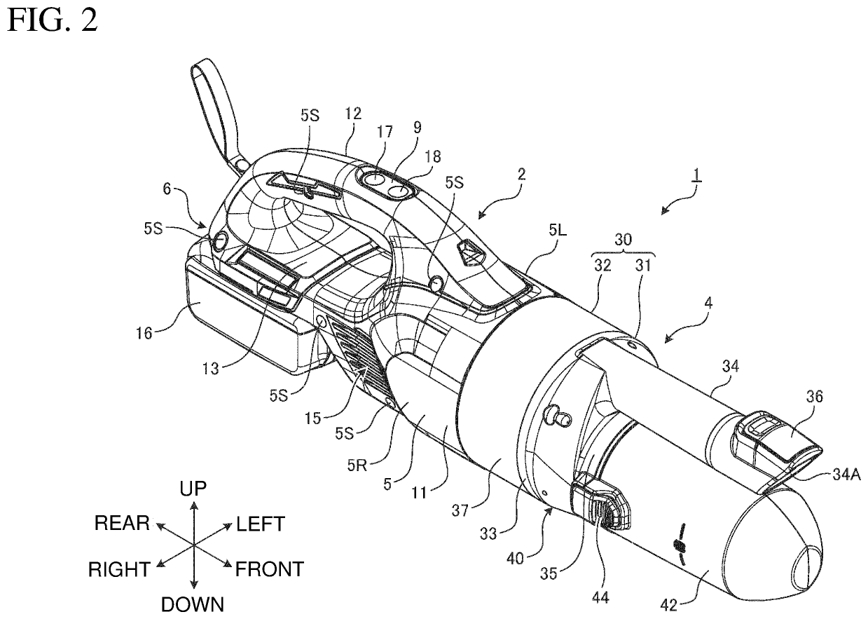

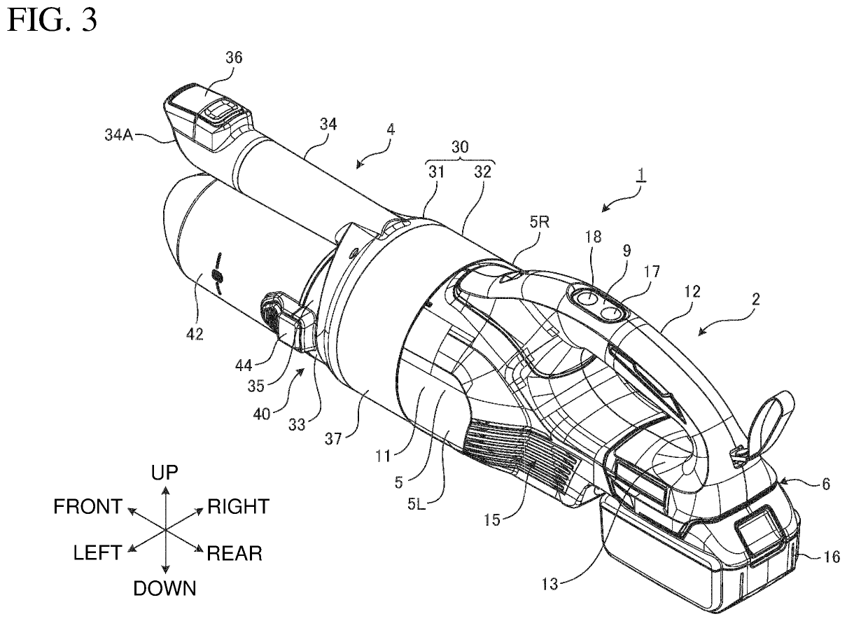

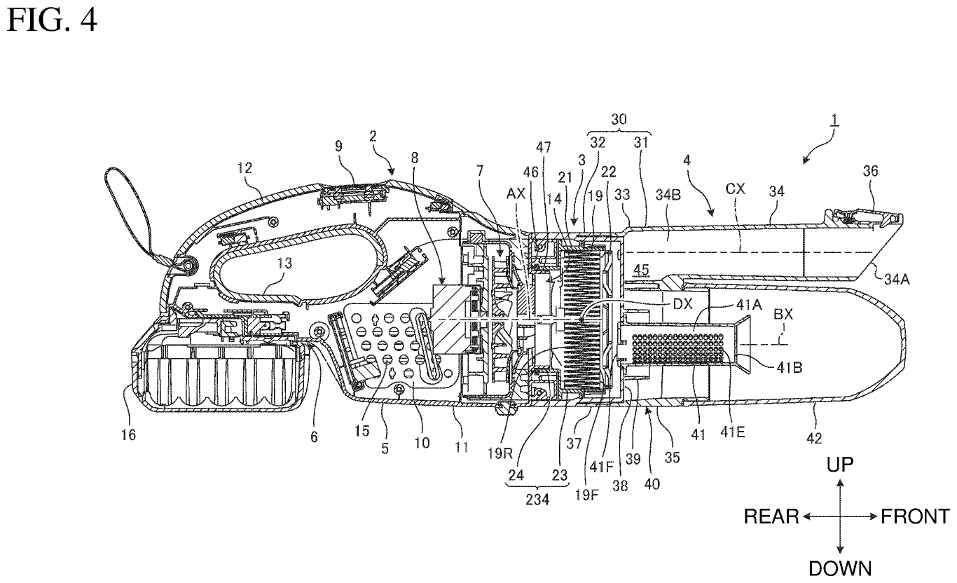

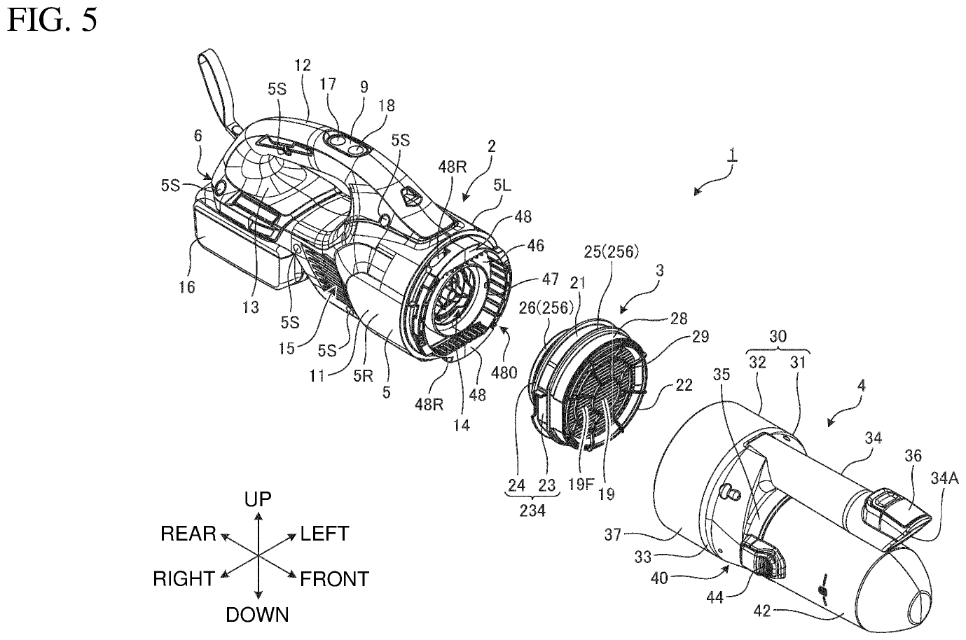

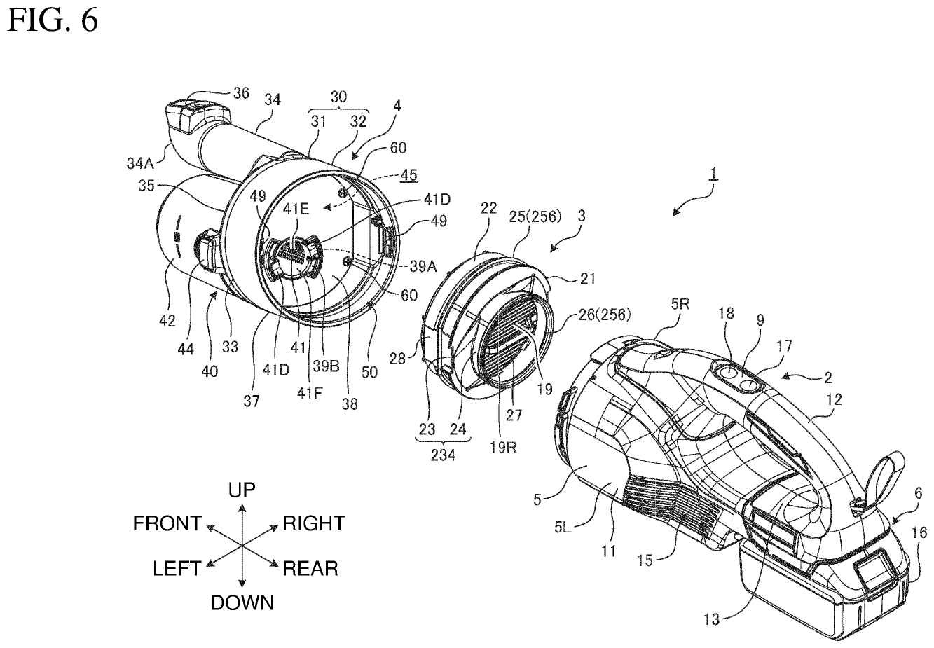

FIG. 1 is a diagram of the cleaner 1 in an example use according to an embodiment, FIG. 2 is a front perspective view of the cleaner 1. FIG. 3 is a rear perspective view of the cleaner 1. FIG. 4 is a cross-sectional view of the cleaner 1. FIG. 5 is an exploded perspective view of the cleaner 1 as viewed from the front. FIG. 6 is an exploded perspective view of the cleaner 1 as viewed from the rear.

The cleaner 1 includes a main unit 2, a filter unit 3, and a cyclone unit 4.

The main unit 2 includes a main housing 5, a battery mount 6, a fan 7, a motor 8, an operation panel 9, and a sound absorber 10.

The main housing 5 is formed from a synthetic resin. The main housing 5 includes a pair of housing halves. The main housing 5 includes a left housing 5L and a right housing 5R. The right housing 5R is located on the right of the left housing 5L. The left and right housings 5L and 5R are fastened together with multiple screws 5S.

The main housing 5 includes a body 11, a grip 12, and a battery holder 13.

The body 11 accommodates the fan 7 and the motor 8. The fan 7 and the motor 8 are located in an internal space of the body 11.

The body 11 has a suction port 14 and exhaust ports 15. The suction port 14 is located in a front portion of the body 11. The exhaust ports 15 are located in left and right portions of the body 11.

The grip 12 is grippable by a user of the cleaner 1. The grip 12 extends rearward from an upper portion of the body 11.

The battery holder 13 holds a battery 16 with a battery mount 6 between them. The battery holder 13 is connected to the rear of the body 11 and to the lower end of the grip 12.

The battery mount 6 is located in a lower portion of the battery holder 13. The battery 16 is attached to the battery mount 6. The battery 16 is detachable from the battery mount 6.

The battery 16 functions as a power supply for the cleaner 1. The battery 16 is attached to the battery mount 6 to power the cleaner 1. The battery 16 is a general-purpose battery for powering various electrical devices. The battery 16 is usable as a power supply for power tools. The battery 16 is usable as a general-purpose battery for powering various electrical devices other than power tools. The battery 16 is usable for powering cleaners other than the cleaner 1 in the embodiment. The battery 16 includes a lithium-ion battery. The battery 16 is rechargeable. The battery mount 6 has the same structure as a battery mount included in a power tool.

The user of the cleaner 1 attaches and detaches the battery 16 to and from the battery mount 6. The battery mount 6 includes a guide and a mount terminal. The guide guides the battery 16. The mount terminal is connectable to a battery terminal on the battery 16.

The user places the battery 16 onto the battery mount 6 from the rear to attach the battery 16 to the battery mount 6. The battery 16 is placed onto the battery mount 6 along the guide. The battery 16 is placed onto the battery mount 6 to electrically connect the battery terminal on the battery 16 and the mount terminal on the battery mount 6. The user of the cleaner 1 moves the battery 16 backward to detach the battery 16 from the battery mount 6.

The fan 7 is accommodated in the body 11 of the main housing 5. The fan 7 is rotatable about a rotation axis AX. The rotation axis AX extends in a front-rear direction. The fan 7 rotates about the rotation axis AX to generate a suction force at the suction port 14. The air flows into an internal space of the main housing 5 from the suction port 14 as the fan 7 rotates, and then flows out of the main housing 5 through the exhaust ports 15.

The motor 8 is accommodated in the body 11 of the main housing 5. The motor 8 generates a rotational force for rotating the fan 7. The motor S is a direct current (DC) brushless motor. The motor 8 includes a cylindrical stator, a rotor, and a rotor shaft. The rotor is located inside the stator. The rotor shaft extends frontward from the rotor. The rotor shaft is fixed to the rotor. The rotation axis AX of the rotor in the motor 8 aligns with the rotation axis AX of the fan 7. The rotor in the motor S rotates about the rotation axis AX. The fan 7 is fixed to the rotor shaft of the motor 8. As the rotor in the motor 8 rotates about the rotation axis AX, the fan 7 rotates about the rotation axis AX. This generates a suction force at the suction port 14.

The operation panel 9 is operable by the user of the cleaner 1. The operation panel 9 is located on the grip 12. The user of the cleaner 1 holding the grip 12 can operate the operation panel 9. The operation panel 9 in the embodiment includes a drive mode switch button 18 and a stop button 17. The drive mode switch button 18 changes the drive conditions of the motor 8. The stop button 17 stops the motor 8.

The motor 8 being stopped starts running in response to an operation on the drive mode switch button 18. This generates a suction force at the suction port 14. The rotational speed of the motor 8 is adjustable, for example, in three steps in response to the drive mode switch button 18 being pushed while the motor 8 is running. While the motor 8 is running, the rotational speed of the motor 8 is changed from the first rotational speed to the second rotational speed in response to one push on the drive mode switch button 18, and from the second rotational speed to the third rotational speed in response to another push on the drive mode switch button 18, and then the rotational speed of the motor 8 returns to the first rotational speed in response to still another push on the drive mode switch button 18. In response to the rotational speed of the motor 8 being changed, the suction force at the suction port 14 changes accordingly. The running motor 8 stops in response to an operation on the stop button 17.

The sound absorber 10 is located in the internal space of the main housing 5, facing the exhaust ports 15. The sound absorber 10 is formed from a porous material. The sound absorber 10 absorbs sound traveling through air to reduce noise. The noise from the cleaner 1 includes noise resulting from an airflow or from rotation of the fan 7.

### Filter Unit

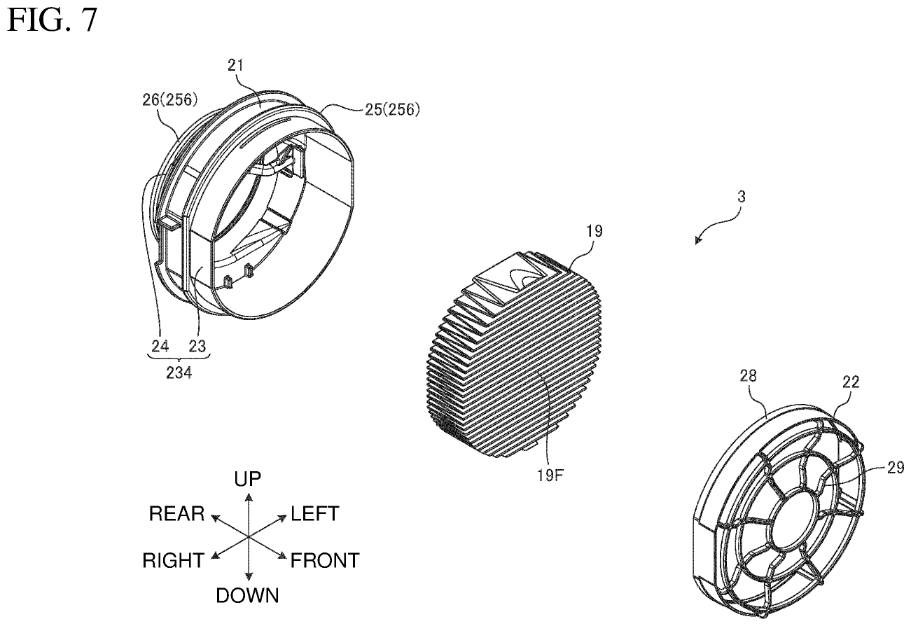

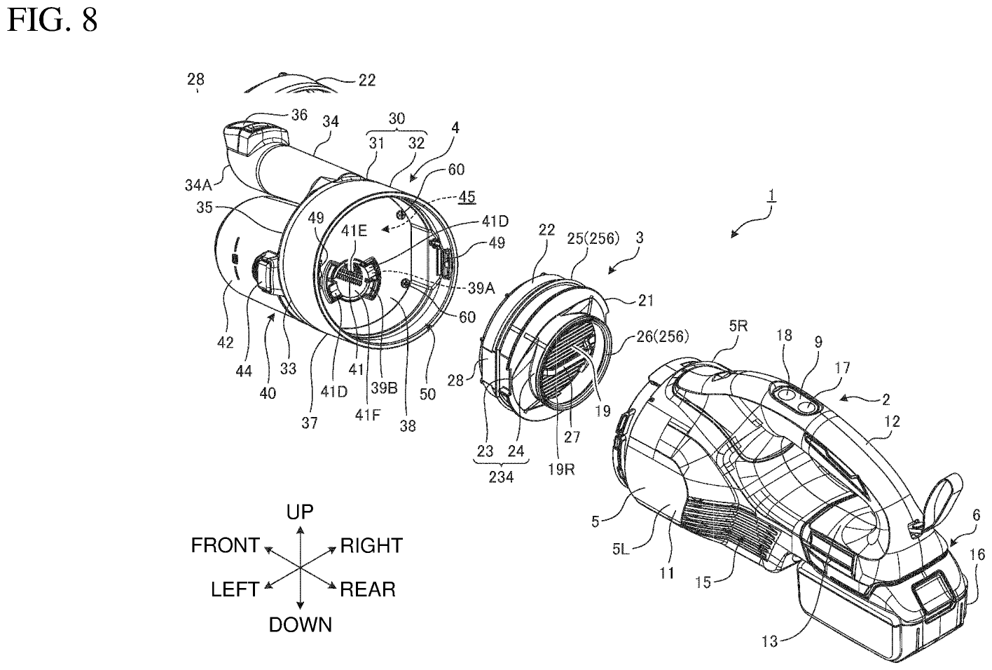

FIG. 7 is an exploded perspective view of the filter unit 3 in the embodiment as viewed from the front. FIG. 8 is an exploded perspective view of the filter unit 3 as viewed from the rear.

As shown in FIGS. 4 to 8, the filter unit 3 includes a filter 19, a filter holder 21, a stay 22, and a seal 256.

The filter 19 is a high-efficiency particulate air filter (HEPA). The filter 19 is located frontward from the suction port 14 in the main unit 2. The suction port 14 is located in a front portion of the main unit 2. The filter 19 has a rear surface 19R and a front surface 19F. The rear surface 19R faces the suction port 14. The front surface 19F faces opposite to the rear surface 19R. Air flows into the filter 19 through the front surface 19F of the filter 19. The filter 19 collects foreign matter from the air flowing through the filter 19. The air passing through the filter 19 flows through the rear surface 19R of the filter 19 and then flows into the suction port 14.

The filter holder 21 holds the filter 19. The filter holder 21 includes a ring 234 and a handle 27. The ring 234 surrounds the filter 19. The handle 27 is connected to the ring 234.

The ring 234 in the embodiment includes a larger-diameter portion 23 and a smaller-diameter portion 24. The larger-diameter portion 23 is located frontward from the smaller-diameter portion 24. The filter 19 is located inside the larger-diameter portion 23.

The seal 256 surrounds the ring 234. The seal 256 in the embodiment includes an annular first seal 25 and an annular second seal 26. The first seal 25 surrounds the outer surface of the larger-diameter portion 23. The second seal 26 is located on the rear end face of the smaller-diameter portion 24.

The handle 27 faces the rear surface 19R of the filter 19. The handle 27 is connected to the smaller-diameter portion 24. The handle 27 is located inside the smaller-diameter portion 24. The handle 27 is a rod. The handle 27 has one end fixed to a first portion of the inner surface of the smaller-diameter portion 24, and the other end fixed to a second portion of the inner surface of the smaller-diameter portion 24. The user of the cleaner 1 can hold the handle 27.

The stay 22 is connected to the front end of the larger-diameter portion 23. The stay 22 is located at least partially in front of the filter 19. The stay 22 includes a frame 28 and a lattice 29. The frame 28 is annular. A cloth filter, for example, is attached to the frame 28. The lattice 29 defines a mesh in front of the filter 19. With the lattice 29, the cloth filter can avoid adhering to the front face of the filter 19,

Air passes through an opening at the front end of the frame 28 and flows through the front surface 19F of the filter 19. Air flowing through the rear surface 19R of the filter 19 passes through the opening at the rear end of the smaller-diameter portion 24.

### Cyclone Unit

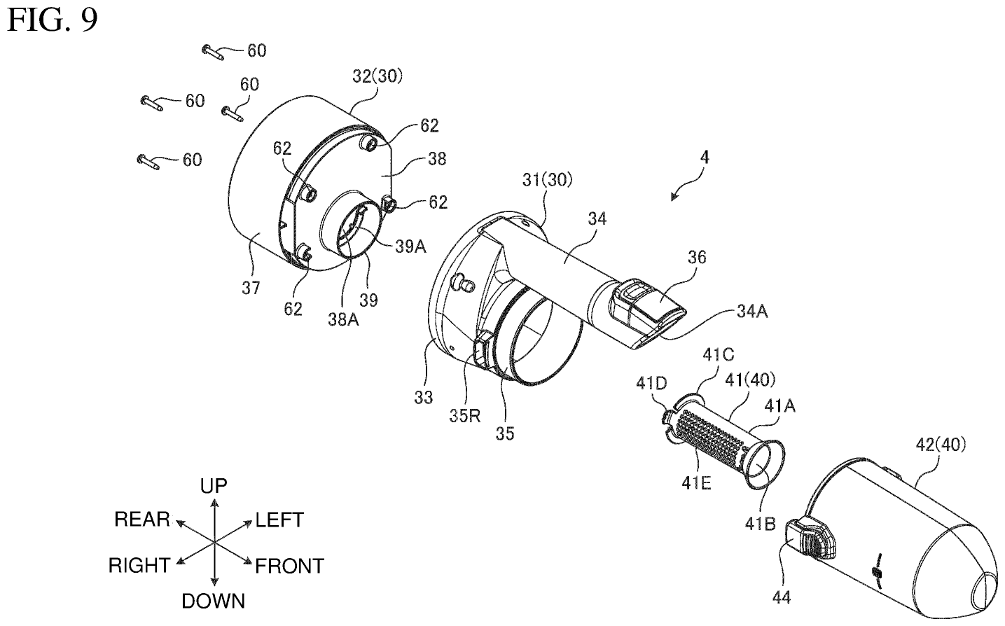

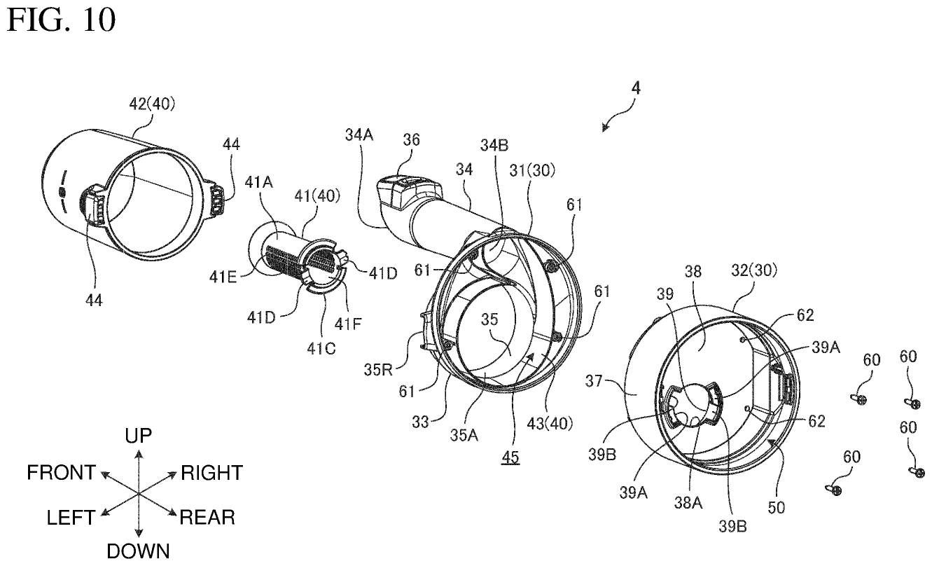

FIG. 9 is an exploded perspective view of the cyclone unit 4 in the embodiment as viewed from the front. FIG. 10 is an exploded perspective view of the cyclone unit 4 in the embodiment as viewed from the rear.

As shown in FIGS. 1 to 6, 9, and 10, the cyclone unit 4 includes a cyclone housing 30 and a cyclone dust collector 40.

The cyclone housing 30 includes a first housing 31 and a second housing 32. The first housing 31 is located at least partially frontward from the second housing 32. The first housing 31 and the second housing 32 are fastened together with four screws 60. The first housing 31 includes threaded holes 61 into which the threads of the screws 60 are screwed. The second housing 32 has openings 62 for receiving middle portions of the screws 60.

The first housing 31 includes a body portion 33, a connecting pipe 34, and a dust cup connector 35.

The second housing 32 includes a cylinder 37, a front plate 38, and a mesh pipe receptacle 39.

The cyclone dust collector 40 includes a mesh pipe 41 and a dust cup 42. The cyclone dust collector 40 also includes a swirl plate 43 in the first housing 31.

The body portion 33 is cylindrical. The body portion 33 is located in a rear portion of the first housing 31. The body portion 33 is connected to the second housing 32. The connecting pipe 34 protrudes frontward from the front of the body portion 33. The dust cup connector 35 is cylindrical. The dust cup connector 35 is located parallel to the connecting pipe 34. The dust cup connector 35 protrudes frontward from the front of the body portion 33.

As shown in FIG. 1, the connecting pipe 34 is connected to the basal end of a pipe 100. The pipe 100 has a distal end connectable to a suction nozzle 101. The suction nozzle 101 includes a suction port.

The connecting pipe 34 includes a lock 36 at its front end. The pipe 100 has a recess. The lock 36 includes a hook to be hung in a recess on the pipe 100. The connecting pipe 34 and the pipe 100 are fastened together with the lock 36. The lock 36 is unlocked to release the pipe 100 from the connecting pipe 34. The pipe 100 is detachable from the connecting pipe 34.

The connecting pipe 34 has an inlet 34A at the front end of the connecting pipe 34 and an outlet 34B at the rear end of the connecting pipe 34. The basal end of the pipe 100 is inserted into the inlet 34A. Air drawn through the suction nozzle 101 flows in through the inlet 34A after passing through the pipe 100. The air through an internal channel in the connecting pipe 34 flows out through the outlet 34B.

The dust cup connector 35 is coupled to the dust cup 42. The dust cup 42 includes a lock 44 at its rear end. The dust cup connector 35 has a recess 35R. The lock 44 includes a hook to be hung in the recess 35R on the dust cup connector 35. The dust cup 42 and the dust cup connector 35 are fastened together with the lock 44. The lock 44 is unlocked to release the dust cup 42 from the dust cup connector 35. The dust cup 42 is detachable from the dust cup connector 35 in the first housing 31.

The dust cup connector 35 has an inlet 35A. The inlet 35A of the dust cup connector 35 functions as an inlet for the cyclone dust collector 40. The inlet 35A is located at the rear end of the dust cup connector 35. The outlet 34B of the connecting pipe 34 is connected to the inlet 35A of the cyclone dust collector 40 through a swirl flow channel 45.

The swirl flow channel 45 is located in the cyclone housing 30. The air flowing out through the outlet 34B of the connecting pipe 34 flows in through the inlet 35A of the cyclone dust collector 40 after passing through the swirl flow channel 45.

The swirl flow channel 45 connects the outlet 34B of the connecting pipe 34 to the inlet 35A of the cyclone dust collector 40. The swirl flow channel 45 is defined by the swirl plate 43. The swirl plate 43 is located inside the body portion 33. When the first housing 31 and the second housing 32 are fastened together with the screws 60, the rear end of the swirl plate 43 in the first housing 31 comes in contact with the front surface of the front plate 38 in the second housing 32. The swirl flow channel 45 in the embodiment is defined by the swirl plate 43 and the front plate 38. The swirl flow channel 45 is located in the cyclone housing 30.

The cylinder 37 is connected to the first housing 31. The front plate 38 covers a front opening of the cylinder 37. The cylinder 37 has an opening 50 at its rear end. The mesh pipe receptacle 39 protrudes frontward from a portion of the front plate 38. The mesh pipe receptacle 39 is cylindrical. The front plate 38 has a through-hole 38A. The through-hole 38A connects the front surface and the rear surface of the front plate 38. The mesh pipe receptacle 39 has an internal space connected to the through-hole 38A,

The cyclone dust collector 40 includes the mesh pipe 41, the dust cup 42, and the swirl plate 43. As described above, the dust cup 42 is detachable from the dust cup connector 35 in the cyclone housing 30. The dust cup 42 has an internal space into which air flows through the inlet 35A of the cyclone dust collector 40.

The mesh pipe 41 is located in the internal space of the dust cup 42. The mesh pipe 41 includes a cylinder 41A, a front plate 41B, a flange 41C, a hook 41D, through-holes 41E, and an outlet 41F.

The front plate 41B covers a front opening of the cylinder 41A. The flange 41C is located at the rear end of the cylinder 41A. The hook 41D is located on the rear end of the cylinder 41A. The hook 41D protrudes radially outward from the rear end of the cylinder 41A. The mesh pipe 41 has two hooks 41D. Each hook 41D protrudes more than the flange 41C in the radial direction of the cylinder 41A. The through-holes 41E connect the inner surface and the outer surface of the cylinder 41A. The through-holes 41E are multiple holes in the cylinder 41A. The air surrounding the mesh pipe 41 flows into the internal channel of the mesh pipe 41 through the through-holes 41E. The outlet 41F is located at the rear end of the cylinder 41A. The air flowing into the internal channel of the mesh pipe 41 through the through-holes 41E flows out through the outlet 41F.

The rear end of the mesh pipe 41 is received in the mesh pipe receptacle 39. The mesh pipe 41 is detachable from the mesh pipe receptacle 39. The mesh pipe receptacle 39 includes an annular support 39A in its rear end to support the flange 41C. The support 39A has notches 39B, through which the hooks 41D are placeable. The hooks 41D placed through the corresponding notches 39B face the rear surface of the support 39A when the mesh pipe 41 is rotated. This fastens the mesh pipe 41 and the second housing 32 together. The mesh pipe 41 is rotated to cause the hooks 41D to align with the notches 39B. The mesh pipe 41 is thus released from the second housing 32. The mesh pipe 41 is detachable from the second housing 32.

The outlet 41F of the mesh pipe 41 functions as an outlet of the cyclone dust collector 40. The air in the internal space of the dust cup 42 flows into the internal channel of the mesh pipe 41 through the through-holes 41E. The air passing through the internal channel of the mesh pipe 41 flows out through the outlet 41F of the cyclone dust collector 40.

### Connection Structure

The connection between the main unit 2, the filter unit 3, and the cyclone unit 4 will now be described with reference to FIGS. 5 and 6.

The filter unit 3 is attached to the main unit 2. The main unit 2 includes an annular rib 47 and an annular support surface 46. The annular rib 47 surrounds the suction port 14. The annular support surface 46 surrounds the annular rib 47. The support surface 46 faces frontward. The annular rib 47 protrudes frontward from the front surface of the main housing 5.

To attach the filter unit 3 to the main unit 2, the smaller-diameter portion 24 is placed to surround the annular rib 47 with its rear end face in contact with the support surface 46. The smaller-diameter portion 24 receives the annular rib 47. The second seal 26 is located at the rear end face of the smaller-diameter portion 24. With the smaller-diameter portion 24 surrounding the annular rib 47, the second seal 26 is in close contact with the support surface 46. The second seal 26 seals between the smaller-diameter portion 24 of the ring 234 and the annular rib 47.

The cyclone unit 4 is attached to the main unit 2. The main unit 2 includes an attachment portion 480 surrounding the suction port 14. The attachment portion 480 attaches and detaches the cylinder 37 in the cyclone unit 4. The attachment portion 480 attaches and detaches the cylinder 37 through rotation relative to the cylinder 37.

The attachment portion 480 includes multiple engagement ribs 48 in a front portion of the main housing 5. The engagement ribs 48 surround the suction port 14. The engagement ribs 48 have engagement grooves 48R on their outer surfaces. The cylinder 37 in the second housing 32 includes protrusions 49 on its inner surface. The protrusions 49 fit into the engagement grooves 48R. The attachment portion 480 in the embodiment includes two engagement ribs 48. The cylinder 37 includes two protrusions 49. The two engagement ribs 48 are located opposite to each other with the suction port 14 in between.

To attach the cyclone unit 4 to the main unit 2, the protrusions 49 are placed between the adjacent engagement ribs 48, and the cyclone unit 4 is rotated to cause the protrusions 49 to fit into the engagement grooves 48R. The cyclone unit 4 and the main unit 2 are fastened together with the protrusions 49 fitted in the engagement grooves 48R. The cyclone unit 4 is rotated to disengage the protrusions 49 from the engagement grooves 48R. The cyclone unit 4 is thus released from the main unit 2. The cyclone unit 4 is detachable from the main unit 2.

The filter unit 3 is also attached to the cyclone unit 4. To attach the filter unit 3 to the cyclone unit 4, the cylinder 37 in the second housing 32 receives the larger-diameter portion 23 through the opening 50. The first seal 25 surrounds the outer surface of the larger-diameter portion 23. With the larger-diameter portion 23 received in the cylinder 37, the first seal 25 is in close contact with the inner surface of the cylinder 37. The first seal 25 seals between the larger-diameter portion 23 of the ring 234 and the cylinder 37.

With the filter unit 3 attached to the main unit 2, the cyclone unit 4 is attached to the main unit 2. This connects the main unit 2, the filter unit 3, and the cyclone unit 4 to one another. With the filter unit 3 attached to the cyclone unit 4, the cyclone unit 4 may be attached to the main unit 2.

Relationship between Filter Unit and Cyclone Unit

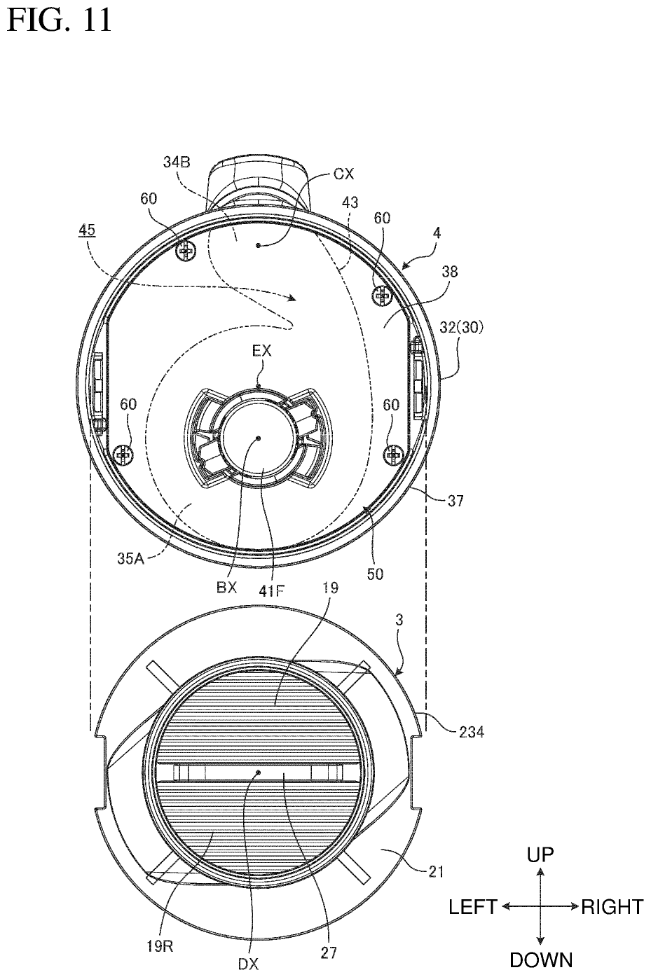

FIG. 11 is a diagram describing the relationship between the filter unit 3 and the cyclone unit 4 in the embodiment. As shown in FIGS. 4 to 6, and 11, the cylinder 37 in the cyclone unit 4 is located rearward from the outlet 41F of the cyclone dust collector 40. The opening 50 of the cylinder 37 is larger than the outlet 41F of the cyclone dust collector 40.

The filter 19 in the filter unit 3 is located frontward from the suction port 14 in the main unit 2. The filter unit 3 is attached to the main unit 2 with the rear surface 19R of the filter 19 and the suction port 14 facing each other.

The filter 19 is located frontward from the suction port 14 to cover the opening 50 of the cylinder 37. The filter unit 3 is attached to the cyclone unit 4 to cover the entire opening 50 with the filter 19.

The filter 19 faces the outlet 41F of the cyclone dust collector 40. The filter unit 3 is attached to the cyclone unit 4 with the front surface 19F of the filter 19 and the outlet 41F facing each other.

The connecting pipe 34 and the cyclone dust collector 40 are located frontward from the cylinder 37. The connecting pipe 34 and the cyclone dust collector 40 are located parallel to each other. The connecting pipe 34 and the cyclone dust collector 40 in the embodiment are located parallel to each other in the vertical direction frontward from the cylinder 37.

The connecting pipe 34 has a central axis CX in the front-rear direction. The mesh pipe 41 has a central axis BX in the front-rear direction. The central axis BX of the mesh pipe 41 is the rotation axis of the cyclone dust collector 40. In the embodiment, the central axis CX of the connecting pipe 34 and the central axis BX of the mesh pipe 41 are parallel to each other.

As shown in FIGS. 4 to 11, the central axis BX of the mesh pipe 41 deviates from a center EX of the opening 50 of the cylinder 37. The outlet 41F of the cyclone dust collector 40 deviates from the center EX of the opening 50 of the cylinder 37. The outlet 41F in the embodiment deviates downward from the center EX of the opening 50 of the cylinder 37.

The center EX of the opening 50 is the center in a plane perpendicular to the rotation axis AX.

The central axis BX of the mesh pipe 41 deviates from a center DX of the filter 19. The outlet 41F of the cyclone dust collector 40 deviates from the center DX of the filter 19. The outlet 41F in the embodiment deviates downward from the center DX of the filter 19.

The center I)X of the filter 19 is the center in the plane perpendicular to the rotation axis AX.

The filter 19 is located to have the center DX aligning with the center EX of the opening 50. The filter unit 3 is attached to the cyclone unit 4 to cause the center DX of the filter 19 to align with the center EX of the opening 50, and to cause the front surface 19F of the filter 19 to face the outlet 41F of the cyclone dust collector 40.

The opening 50 overlaps the central axis CX of the connecting pipe 34 and the central axis BX of the mesh pipe 41 in the plane perpendicular to the rotation axis AX. The opening 50 also overlaps the outlet 34B of the connecting pipe 34 and the outlet 41F of the cyclone dust collector 40 in the plane perpendicular to the rotation axis AX.

The filter 19 overlaps the central axis CX of the connecting pipe 34 and the central axis BX of the mesh pipe 41 in the plane perpendicular to the rotation axis AX. The filter 19 also overlaps the outlet 34B of the connecting pipe 34 and the outlet 41F of the cyclone dust collector 40 in the plane perpendicular to the rotation axis AX.

The rotation axis AX aligns with at least a part of the filter 19 in the plane perpendicular to the rotation axis AX. The filter 19 in the embodiment is located to have the center DX aligning with the rotation axis AX.

### Method of Use

The use of the cleaner 1 will now be described. The drive mode switch button 18 is operated to drive the motor 8, and then the fan 7 rotates. This generates a suction force at the suction port 14. The air is then sucked into the pipe 100 together with foreign matter from the suction nozzle 101. The foreign matter includes dust. The air flowing through the pipe 100 flows into the internal channel in the connecting pipe 34 through the inlet 34A of the connecting pipe 34. The air flowing through the internal channels in the connecting pipe 34 flows out through the outlet 34B of the connecting pipe 34.

The outlet 34B of the connecting pipe 34 is connected to the inlet 35A of the cyclone dust collector 40 through the swirl flow channel 45 in the cyclone housing 30. The air flowing out through the outlet 34B of the connecting pipe 34 flows into the cyclone dust collector 40 through the inlet 35A after passing through the swirl flow channel 45,

The air flowing into the cyclone dust collector 40 includes air flowing into the internal space of the dust cup 42. The air flowing into the internal space of the dust cup 42 through the swirl flow channel 45 swirls in the internal space of the dust cup 42. The air and the foreign matter are separated from each other in the dust cup 42. The foreign matter accumulates on the dust cup 42. The air separated from the foreign matter passes through the mesh pipe 41 and flows out through the outlet 41F of the cyclone dust collector 40.

The outlet 41F of the cyclone dust collector 40 is connected to an internal space of the cylinder 37. The air flowing out through the outlet 41F of the cyclone dust collector 40 and then flowing into the internal space of the cylinder 37 flows through the filter 19 in the filter unit 3. The filter 19 collects minute particles of foreign matter not collected by the cyclone dust collector 40. The air passing through the filter 19 flows into the internal space of the main housing 5 through the suction port 14 after passing through the opening at the rear end of the filter holder 21. The air flowing into the internal space of the main housing 5 is discharged out of the main housing 5 through the exhaust ports 15 after passing through the fan 7 and the motor 8.

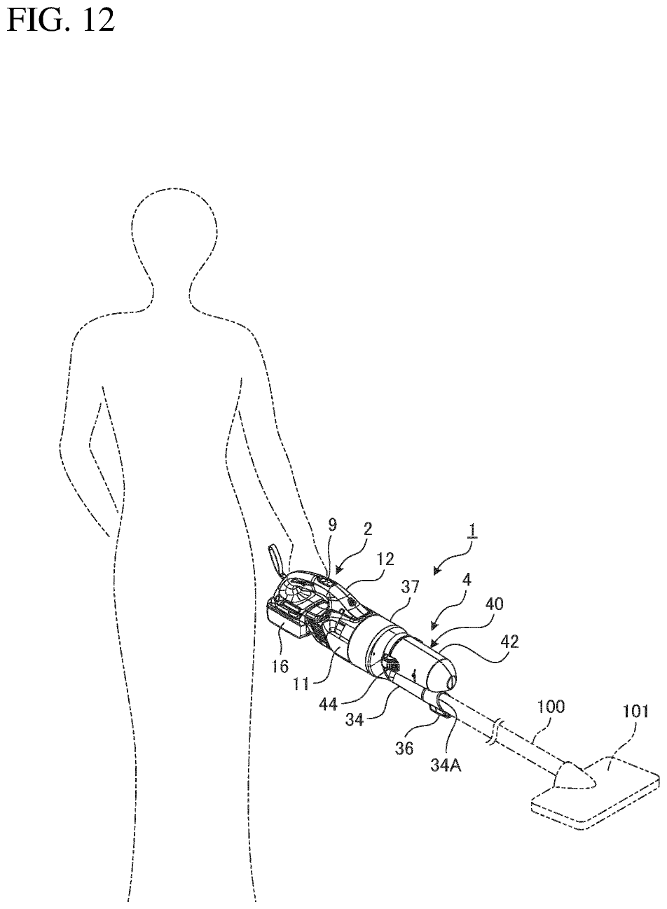

FIG. 12 is a diagram of the cleaner 1 in an example use according to the embodiment. As described above, the attachment portion 480 includes the engagement ribs 48, and the cylinder 37 includes the protrusions 49. The main unit 2 and the cyclone unit 4 are attached to and detached from each other through relative rotation between them.

As shown in FIGS. 1 and 12, the relative position of the main unit 2 and the cyclone unit 4 in the rotation direction can be set to any position. The attachment portion 480 can lock the cylinder 37 at either the first position or at the second position different from the first position in the rotation direction. At the first position of the cylinder 37 in the rotation direction, as shown in FIG. 1, the connecting pipe 34 is above the dust cup 42 when the grip 12 is above the body 11. At the second position of the cylinder 37 in the rotation direction, as shown in FIG. 12, the connecting pipe 34 is above the dust cup 42 when the grip 12 is above the body 11.

As described above, the two engagement ribs 48 surround the suction port 14. The two protrusions 49 are located on the inner surface of the cylinder 37. The protrusions 49 on the cylinder 37 fit into the engagement grooves 48R on the engagement ribs 48, thus fixing the position of the cylinder 37 in the rotation direction. The user of the cleaner 1 can fix the cylinder 37 at one of the first and second positions by changing the combination of the two engagement ribs 48 and the protrusions 49 that fit into the respective engagement grooves 48R on the two engagement ribs 48.

As described above, the cyclone unit 4 in the embodiment includes the cyclone dust collector 40 and the cylinder 37 located rearward from the outlet 41F of the cyclone dust collector 40. The cylinder 37 has the opening 50 larger than the outlet 41F of the cyclone dust collector 40. The filter 19 is located frontward from the suction port 14 of the main unit 2 to cover the entire opening 50. The outer diameter of the filter 19 is larger than the outlet 41F. This structure can thus reduce deterioration of the performance of the filter 19 as a foreign matter collector when the filter 19 has a shortened dimension in the front-rear direction. More specifically, with the large outer diameter of the filter 19, the surface area of the filter 19 in contact with foreign matter is large although the filter 19 has a shortened dimension in the front-rear direction. The filter 19 can have a shortened dimension in the front-rear, thus reducing the overall length of the cleaner 1.

The outlet 41F of the cyclone dust collector 40 is connected to the internal space of the cylinder 37. The air flowing out through the outlet 41F of the cyclone dust collector 40 and then flowing into the internal space of the cylinder 37 flows through the filter 19. In this manner, the filter 19 collects minute particles of foreign matter not separated from the air in the cyclone dust collector 40.

The outlet 41F of the cyclone dust collector 40 deviates from the center EX of the opening 50. The cyclone dust collector 40 is thus located parallel to another component, such as the connecting pipe 34. This structure reduces the overall size increase of the cleaner 1.

The filter 19 faces the outlet 41F of the cyclone dust collector 40. In this manner, the air flowing out through the outlet 41F of the cyclone dust collector 40 flows efficiently through the filter 19.

The filter 19 is located to have the center DX aligning with the center of the opening 50. The filter 19 thus covers the entire opening 50, while reducing the overall size increase of the cleaner 1.

The main unit 2 includes the main housing 5 with the suction port 14, the fan 7 accommodated in the main housing 5, and the motor 8 accommodated in the main housing 5 for rotating the fan 7. The fan 7 rotates to generate a suction force at the suction port 14. The rotation axis AX aligns with at least a part of the filter 19 in the plane perpendicular to the rotation axis AX of the fan 7. This structure reduces the overall size increase of the cleaner 1. The suction force generated at the suction port 14 acts appropriately on the filter 19.

The filter 19 is located to have the center DX aligning with the rotation axis AX. This structure reduces the overall size increase of the cleaner 1. The suction force generated at the suction port 14 acts appropriately on the filter 19.

The cyclone unit 4 includes the connecting pipe 34 located frontward from the cylinder 37. The air flowing out through the outlet 34B of the connecting pipe 34 flows into the cyclone dust collector 40. In this manner, the air flowing out through the outlet 34B of the connecting pipe 34 is separated from the foreign matter in the cyclone dust collector 40.

The connecting pipe 34 and the cyclone dust collector 40 are located parallel to each other frontward from the cylinder 37. The opening 50 overlaps the outlet 34B of the connecting pipe 34 and the outlet 41F of the cyclone dust collector 40. This increases the size of the outer diameter of the filter 19, while reducing the overall size increase of the cleaner 1.

The cyclone unit 4 includes the cyclone housing 30 with the swirl flow channel 45 connecting the outlet 34B of the connecting pipe 34 and the inlet 35A of the cyclone dust collector 40. In this manner, the air flowing out through the outlet 34B of the connecting pipe 34 flows into the cyclone dust collector 40 while swirling.

The cyclone housing 30 includes the cylinder 37 and the connecting pipe 34. The cylinder 37 and the connecting pipe 34 are integrated, thus avoiding complicating the structure of the cyclone unit 4.

The cyclone dust collector 40 includes the dust cup 42 with the internal space into which air flows through the inlet 35A of the cyclone dust collector 40, and the mesh pipe 41 located in the internal space of the dust cup 42. The dust cup 42 is detachable from the cyclone housing 30. For example, the dust cup 42 detached from the cyclone housing 30 can be cleaned. When the dust cup 42 is attached to the cyclone housing 30, foreign matter separated from the air accumulates on the dust cup 42.

The central axis CX of the connecting pipe 34 and the central axis BX of the mesh pipe 41 are parallel to each other. This structure reduces the overall size increase of the cleaner 1.

The main unit 2 includes the attachment portion 480 for attaching or detaching the cylinder 37. The user of the cleaner 1 can thus easily attach or detach the main unit 2 to or from the cyclone unit 4.

The attachment portion 480 surrounds the suction port 14, and attaches or detaches the cylinder 37 through rotation relative to the cylinder 37. The user of the cleaner 1 can thus easily attach or detach the main unit 2 to or from the cyclone unit 4 by rotating the main unit 2 and the cyclone unit 4 relative to each other. This also eliminates any additional structure related to the attachment portion on the outer surface of the main unit 2 or on the outer surface of the cyclone unit 4. This structure reduces the overall size increase of the cleaner 1.

The attachment portion 480 can lock the cylinder 37 at either the first position or at the second position different from the first position in the rotation direction. As described with reference to FIG. 1, the main unit 2 and the cyclone unit 4 can be connected to cause the connecting pipe 34 to be above the dust cup 42. As described with reference to FIG. 12, the main unit 2 and the cyclone unit 4 can be connected to cause the dust cup 42 to be above the connecting pipe 34. For any obstacle around the cleaner 1 in the cleaning work with the cleaner 1, the user of the cleaner 1 can change the connection state between the main unit 2 and the cyclone unit 4 to prevent the obstacle from interfering with the cleaning operation.

The filter unit 3 includes the filter 19 and the filter holder 21 holding the filter 19. The filter 19 held in the filter holder 21 can collect foreign matter.

The filter unit 3 is attached to the main unit 2. This appropriately positions the filter unit 3 relative to the main unit 2.

The filter holder 21 includes the ring 234 surrounding the filter 19 and the handle 27 facing the rear surface 19R of the filter 19 and connected to the ring 234. To attach or detach the filter unit 3 to or from the cyclone unit 4, the user of the cleaner 1 pinches the handle 27 with fingers and moves the filter unit 3. Clean air passing through the filter 19 flows through the rear surface 19R of the filter 19. The handle 27 faces the rear surface 19R of the filter 19. This structure reduces contamination of the handle 27.

The main unit 2 includes the annular rib 47 surrounding the suction port 14. The second seal 26 seals between the ring 234 and the annular rib 47. This prevents foreign matter around the filter unit 3 from entering the inside of the ring 234. This structure reduces the contamination of the handle 27.

### Other Embodiments

In the embodiment described above, the filter unit 3 includes the filter 19 held in the filter holder 21 and a cloth filter attached to the stay 22. The filter 19 is used in the filter unit 3 and the cloth filter may be eliminated. The cloth filter is used in the filter unit 3 and the filter 19 may be eliminated. The user of the cleaner 1 can selectively use one or both of the filter 19 and the cloth filter.

In the above embodiment, the cyclone housing 30 includes the first housing 31 and the second housing 32. The first housing 31 may be integral with the second housing 32.

In the above embodiments, the central axis CX of the connecting pipe 34 and the central axis BX of the mesh pipe 41 may not be parallel to each other.

### REFERENCE SIGNS LIST

1 cleaner
2 main unit
3 filter unit
4 cyclone unit
5 main housing
5L left housing
5R right housing
5S screw
6 battery mount
7 fan
8 motor
9 operation panel
10 sound absorber
11 body
12 grip
13 battery holder
14 suction port
15 exhaust port
16 battery
17 stop button
18 drive mode switch button
19 filter
19F front surface
19R rear surface
21 filter holder
22 stay
23 larger-diameter portion
24 smaller-diameter portion
25 first seal
26 second seal
27 handle
28 frame
29 lattice
30 cyclone housing
31 first housing
32 second housing
33 body portion
34 connecting pipe
34A inlet
34B outlet
35 dust cup connector
35A inlet
35R recess
36 lock
37 cylinder
38 front plate
38A through-hole
39 mesh pipe receptacle
39A support
39B notch
40 cyclone dust collector
41 mesh pipe
41A cylinder
41B front plate
41C flange
41D hook
41E through-hole
41F outlet
42 dust cup
43 swirl plate
44 lock
45 swirl flow channel
46 support surface
47 annular rib
48 engagement rib
48R engagement groove
49 protrusion
50 opening
60 screw
61 threaded-hole
62 opening
100 pipe
101 suction nozzle
234 ring
256 seal
480 attachment portion
AX rotation axis
BX central axis
CX central axis
DX center
EX center

1. A cleaner, comprising:
a main unit including a suction port;
a cyclone unit including
a cyclone dust collector having an outlet, and
a cylinder located rearward from the outlet of the cyclone dust collector, the cylinder having an opening larger than the outlet of the cyclone dust collector; and
a filter located frontward from the suction port and covering the opening.

2. The cleaner according to claim 1, wherein
air flowing into an internal space of the cylinder through the outlet of the cyclone dust collector flows through the filter.

3. The cleaner according to claim 1, wherein
the outlet of the cyclone dust collector deviates from a center of the opening of the cyclone dust collector.

4. The cleaner according to claim 3, wherein
the filter faces the outlet of the cyclone dust collector.

5. The cleaner according to claim 4, wherein
the filter has a center aligning with the center of the opening.

6. The cleaner according to claim 1, wherein
the main unit includes
a main housing including the suction port,
a fan accommodated in the main housing, and
a motor accommodated in the main housing to rotate the fan, and
the fan has a rotation axis aligning with at least a part of the filter in a plane perpendicular to the rotation axis of the fan.

7. The cleaner according to claim 6, wherein
the filter has a center aligning with the rotation axis.

8. The cleaner according to claim 1, wherein
the cyclone unit includes a connecting pipe located frontward from the cylinder, and
air flowing out through an outlet of the connecting pipe flows into the cyclone dust collector.

9. The cleaner according to claim 8, wherein
the connecting pipe and the cyclone dust collector are parallel to each other, and
the opening overlaps with the outlet of the connecting pipe and with the outlet of the cyclone dust collector.

10. The cleaner according to claim 8, wherein
the cyclone unit includes a cyclone housing including a swirl flow channel connecting the outlet of the connecting pipe and an inlet of the cyclone dust collector.

11. The cleaner according to claim 10, wherein
the cyclone housing includes the cylinder and the connecting pipe.

12. The cleaner according to claim 10, wherein
the cyclone dust collector includes
a dust cup including an internal space into which air flows through the inlet of the cyclone dust collector, and
a mesh pipe in the internal space of the dust cup, and
the dust cup is attachable to and detachable from the cyclone housing.

13. The cleaner according to claim 12, wherein
air passing through the mesh pipe flows out through the outlet of the cyclone dust collector, and
the connecting pipe has a central axis parallel to a central axis of the mesh pipe.

14. The cleaner according to claim 1, wherein
the main unit includes an attachment portion configured to attach or detach the cylinder.

15. The cleaner according to claim 14, wherein
the attachment portion surrounds the suction port to attach and detach the cylinder through rotation relative to the cylinder.

16. The cleaner according to claim 15, wherein
the attachment portion locks the cylinder at a first position or at a second position different from the first position in a rotation direction.

17. The cleaner according to claim 1, further comprising:
a filter unit, the filter unit including the filter and a filter holder holding the filter.

18. The cleaner according to claim 17, wherein
the filter unit is attached to the main unit.

19. The cleaner according to claim 18, wherein
the filter holder includes
a ring surrounding the filter, and
a handle facing a rear surface of the filter and connected to the ring,
the main unit includes an annular rib surrounding the suction port, and
the filter unit includes a seal to seal between the ring and the annular rib.

20. The cleaner according to claim 2, wherein
the outlet of the cyclone dust collector deviates from a center of the opening of the cyclone dust collector.
